(19) United States
(12) Patent Application Publication
(10) Pub. No.: US 2026/0120550 A1
(43) Pub. Date: Apr. 30, 2026

(54) METHOD, APPARATUS, AND SYSTEM FOR CONSOLIDATED VIEWING FROM MULTIPLE CAMERAS

(71) Applicant: HANWHA VISION CO., LTD., Seongnam-si (KR)

(72) Inventor: Jeffrey M. Sweeney, Carlsbad, CA (US)

(73) Assignee: HANWHA VISION CO., LTD., Seongnam-si (KR)

(21) Appl. No.: 18/932,633

(22) Filed: Oct. 31, 2024

(51) Int. Cl. G08B 13/196

(52) U.S. Cl. CPC G08B 13/19693; G08B 13/19608; G08B 13/19641

(57) ABSTRACT

Disclosed is a scheme for displaying a combined view comprising a comprehensive 2D view of the multi-camera coverage area together with a quasi-3D view of at least a portion of the target of interest. Such is achieved by performing image processing on video feeds from multiple cameras to provide a consolidated multi-camera viewing experience on a single display window or screen that offers more user efficiency and comprehensive intelligence related to the target of interest when compared to a system that lacks the processor and the network interface.

### RELATED ART

The present disclosure broadly relates to image processing that involves recognition of people or objects in images of a coverage area captured by one or more cameras, performing image data processing thereof to achieve consolidated viewing.

### BACKGROUND

An example of the related or background art can be found in KR102339825B1 entitled: “Device for situation awareness and method for stitching image thereof.” Its English translation abstract, in part, states that: “the present invention is to provide a stitching-based device for situation recognition and a method for stitching an image thereof capable of generating a panoramic image reflecting information from an observer's viewpoint in stitching images taken by a plurality of cameras having different viewing angles.”

Another example of the related or background art can be found in U.S. Pat. No. 10,979,645B2 entitled: “Video capturing device including cameras and video capturing system including the same.” Its abstract states the following: “A video capturing device may include a video calibrator connected to one or more fixed cameras and a PTZ camera. The video calibrator may receive a first image captured by the one or more fixed cameras and a second image acquired by performing image capturing while moving the PTZ camera, search an image area matched with the first image within a reference window which is specified in the second image according to a default value associated with an aiming direction of the fixed camera, and output information associated with the searched image area.”

It should be noted that both KR102339825B1 and U.S. Pat. No. 10,979,645B2 are commonly owned by Applicant and the disclosures thereof are incorporated by reference in their entirety, respectively, and thus form part of this disclosure.

### BRIEF SUMMARY

In such related or background art, depending upon where and how such surveillance systems and methods are implemented, certain improvements and/or enhancements thereto may be needed. Thus, to address such needs, according to at least some embodiments described herein, a scheme for consolidating views from multiple cameras has been developed.

### BRIEF DESCRIPTION OF DRAWINGS

The accompanying figures, where like reference numerals refer to identical or functionally similar elements throughout the separate views and which together with the detailed description below are incorporated in and form part of the specification, serve to further illustrate various embodiments and to explain certain principles and effects in accordance with the present disclosure.

FIG. 1 is a conceptual diagram (100) showing the relationships between particular exemplary hardware and software elements that are applicable to one or more embodiments according to the present disclosure.

FIG. 2 is a conceptual diagram (200) for explaining some basic aspects related to one or more embodiments of the present disclosure.

FIG. 3 is a conceptual diagram (300) for explaining some aspects with respect to the evolution of the 2D to 3D viewing experience for a user.

FIG. 4 shows an exemplary Phase 1 implementation (400) according to one or more embodiments of the present disclosure.

FIG. 5 shows an exemplary Phase 2 implementation (500) according to one or more embodiments of the present disclosure.

FIG. 6 shows an exemplary Phase 3 implementation (600) according to one or more embodiments of the present disclosure.

FIG. 7 depicts to a first embodiment (700) of the present disclosure.

FIG. 8 depicts to a second embodiment (800) of the present disclosure.

FIG. 9 depicts a third embodiment (900) of the present disclosure.

Those skilled in the art will appreciate that some elements in the figures are illustrated for simplicity and clarity and have not necessarily been drawn to scale. The dimensions of some elements in the figures may be exaggerated relative to other elements to help to improve understanding of embodiments of the present disclosure.

### DETAILED DESCRIPTION

Before explaining the embodiments in detail, it should be understood that the inventive features described herein are not limited in its application to the details in the construction or arrangement of components or method steps set forth in the following description or illustrated in the drawings. The inventive features are capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings, unless specified as such.

The following disclosure is presented to enable a person skilled in the art to make and use embodiments being described. Various modifications to the embodiments will be readily apparent to those skilled in the art, and the generic principles herein can be applied to other embodiments and applications. Thus, the inventive features are not intended to be limited to the embodiments shown but are to be accorded the widest scope consistent with the principles and features disclosed herein. The following detailed description is to be read with reference to the figures that depict selected embodiments and are not intended to limit the scope thereof. Skilled artisans will recognize the examples provided herein have many useful alternatives that still fall within the scope of the embodiments.

The present inventor specifically recognized certain shortcomings in the related art and/or the background art, which led to in-depth research and development activities for achieving the specific technical improvements and/or enhancements with respect to video surveillance implementations to be described hereafter.

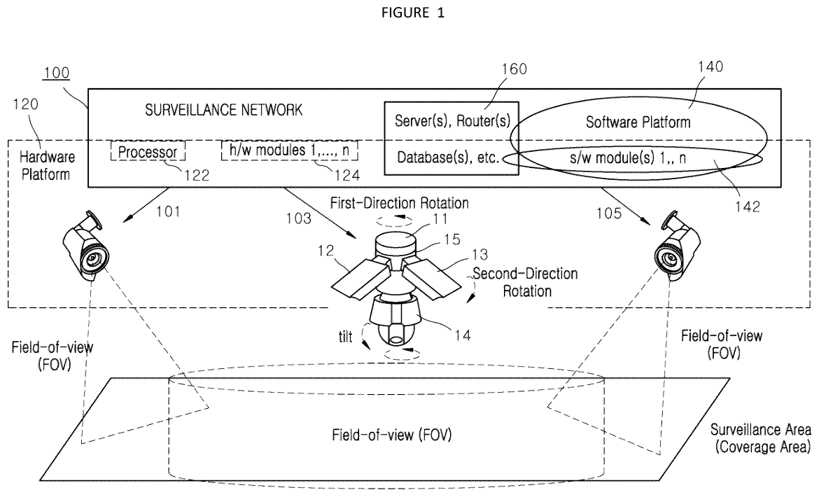

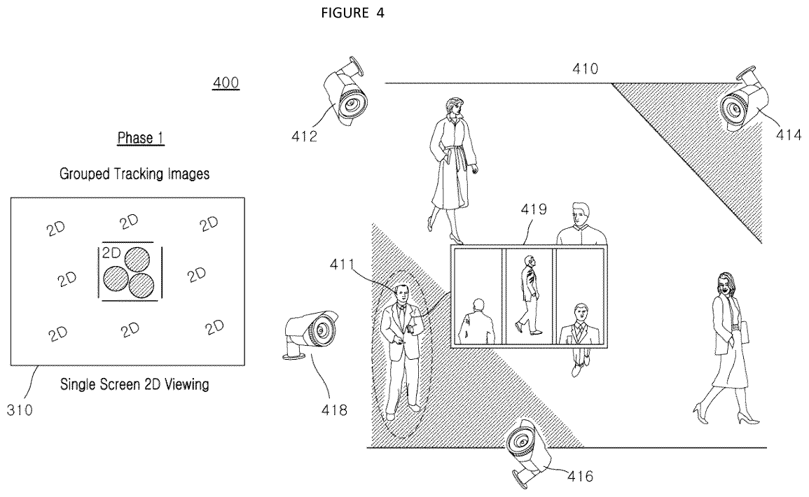

Common theme(s) for multiple or all embodiments With reference to FIGS. 1 through 3, at least some basic concepts and/or broad features related to one or more embodiments can be described in the following manner. In addition, FIGS. 4 through 6 respectively show some exemplary Phase 1, Phase 2 and Phase 3 implementations (400, 500, 600) according to one or more embodiments of the present disclosure.

With reference to FIG. 1, at least some embodiments provide for a system (100) comprising a plurality of security cameras (101, 103, 105) that are networked together, each camera having related thereto: a hardware platform (120) and a software platform (140) comprising software modules (142) that support the hardware platform, wherein a combination of the cameras, the hardware platform and the software platform cooperate to provide improved surveillance, communications and safety when compared to a system that lacks the combination.

Here, the security cameras may be those that are currently used in the surveillance industry. For example, Hanwha's products for pan tilt zoom (PTZ) cameras can be employed, but the embodiments described herein are not limited thereto. The features of such cameras (as explained in commonly owned U.S. patents, such as U.S. Pat. Nos. 10,043,079B2, 10,783,648B2 and 10,341,616B2) will not be explained in detail but are still part of this disclosure via incorporation by reference of these patents in their entirety. The network connectivity can be achieved in a variety of ways, including but not limited to, LAN connections, wireless communications, ad hoc networking, edge computing, telecommunications and the like.

Also, the security cameras each have a particular field-of-view (FOV), which are depicted conceptually in FIG. 1. For example, one or more fixed cameras (101, 105) may have a fixed FOV to cover a certain region of the surveillance area. A more sophisticated camera, such as the movable camera (103) will have a much larger FOV, which covers a broader region of the surveillance area. It can be clearly understood by those skilled in the art that FIG. 1 is merely exemplary, and that various other types of cameras, image pick-up devices, sensors, installation schemes, coverage areas, and the like can be adapted and implemented, as all such details would fall within the technical scope of the embodiments described herein.

The hardware platform contains one or more processor (122) and/or controllers that provide overall control for the system. Additionally, image and video processing that employs metadata, image data, histograms, artificial intelligence (AI), machine learning (ML), and the like are supported by the hardware platform.

The visual alerts module includes light sources and/or other elements that provide visible cues or outputs. The particular types, sizes, layouts, configurations, etc. of such visual alerts can be varied according to the specific implementation needs.

The audible alerts module includes input and output devices, such as microphones and speakers, that support audible interfacing related to the area under surveillance. Sounds, alerts, and the like can be provided to person(s) in the surveillance area and voice commands can be picked up and processed as well.

The software platform contains various types of modules (142), which contain instructions and/or software codes that are executable by the processor and/or controller in the hardware platform. The processing needed to support various types of video codecs and audio codecs are also performed in the software platform, upon cooperation with elements in the hardware platform.

The hardware and software platforms can contain elements or features that are interchangeable or substituted. In some embodiments, certain features could be implemented as firmware and/or other types of hardware-software combination.

In such system, each camera operates in an active manner according to event-driven or schedule-driven signaling, rather than based upon simple motion detection.

Here, event-driven signaling refers to processing or signal generation based upon one or more events or occurrences that take place at or near one or more security cameras. Such events may be detected in an automatic manner via sensors or detectors. Alternatively, such detection can be done manually by an operator or manager and a viewing station that allows monitoring of all or multiple security cameras for a particular surveillance area.

Schedule-driven signaling refers to processing or signal generation based upon a schedule according to set time periods. For example, if the system is implemented in a commercial environment such as a store, the visual and audible alerts can be set for triggering during the hours when the store is closed. Such scheduling can be set for automatic operation or for manual operation.

In such system, the cameras, the hardware platform and the software platform employ at least one among artificial intelligence (AI) video processing and video analytics that support edge computing techniques to achieve the improved user awareness.

Here, in order to provide improved user awareness with respect to surveillance, communications and safety, features related to artificial intelligence (A.I.) can be additionally employed. For example, certain situations that trigger the visual and audible alerts according to some embodiments herein can be anticipated ahead of time. If the image or video feeds from the security cameras show that an overcrowding situation could be forthcoming, the system could provide alerts in a more timely manner as safety hazard issues could be accurately predicted by using A.I. or machine learning algorithms based upon the video or image data that is currently being captured. Of course, such A.I., machine learning, or other similar techniques may be employed for other situation that need anticipation or prediction, which fall under the scope of the embodiments described herein.

Here, the system according to the present disclosure can have user interactive functions that allow voice or sounds to be recognized. For example, in order to provide immediate verbal assistance or guidance to a user in a surveillance area, some embodiments herein are equipped with 2-way voice functions. As such, a system monitoring staff member may observe a situation via a particular security camera and provide verbal instructions to that user at that location.

Also, such cameras may support nighttime image capture capabilities, which can be achieved in a variety of ways, including but not limited to infrared (IR) imaging, night vision technologies, color night vision, thermal imaging, and the like.

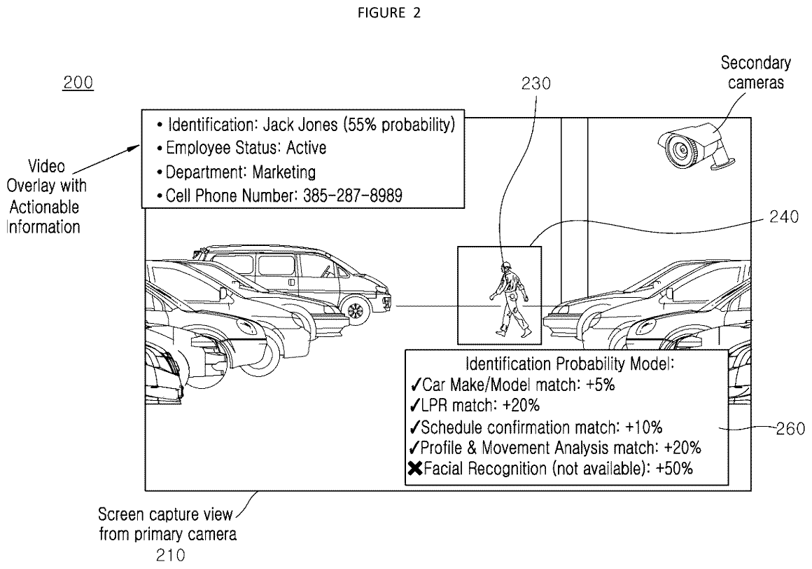

FIG. 2 shows a conceptual diagram (200) with respect to the viewing experience for a user. Before getting into the details about Phases 1 through 3, it can be considered that a “Phase 0” would exist before Phase 1 of the 2D to 3D viewing experience evolution.

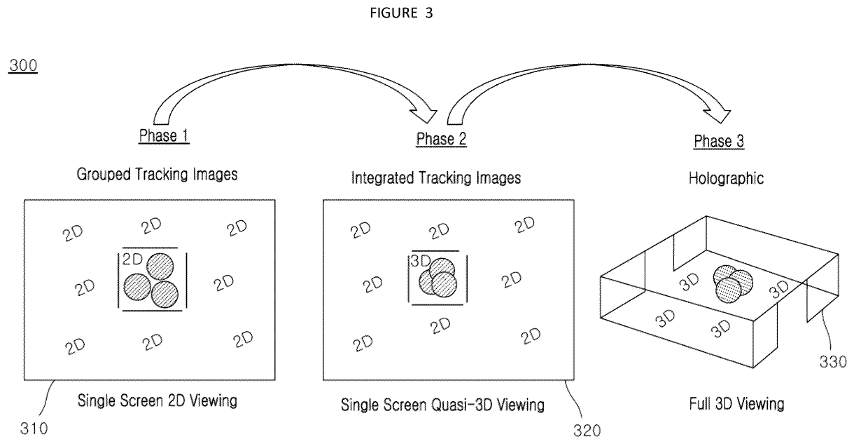

FIG. 3 shows another conceptual diagram (300) with respect to the evolution of the 2D to 3D viewing experience for a user. Here, three phases are shown: Phase 1 (Grouped Tracking Images: Single Screen 2D Viewing), Phase 2 (Integrated Tracking Images: Single Screen Quasi-3D Viewing), and Phase 3 (Holographic displaying: Full 3D Viewing).

With reference to FIG. 2, an exemplary situation where a person (230) is walking through a crowded parking lot adjacent to a large building is depicted.

Phase 0 refers to providing a useful user viewing experience (200) that is less data processing intensive than the image processing performed for single screen 2D viewing (Phase 1).

Such Phase 0 would leverage the analytics gathered from the secondary cameras (220) to drive “intelligence” of the person or object (230) being tracked and displayed by the primary camera (210). As an example, the primary camera may place a green bounding box (240) (or other type of graphical depiction on the screen) around a person (230) to visually designate “normal” or “no threat” when the person (i.e., the individual being tracked) initially enters a coverage area. If, however, a secondary camera (220) identifies a weapon or other object of interest on that person (which may be hidden from view of the primary camera (210)), this “intelligence” is passed on for analytics processing, which can result in the color of the bounding box (240) surrounding the individual being tracked and viewed from the primary camera (210) to change from, as an example, green to yellow. Such visual notification provides the operator, or other user who views or tracks a particular person, with additional information (i.e., “enhanced intelligence”) that is used to determine how the tracking of that person or object should be further processed.

To provide the enhanced intelligence, AI modeling is employed to learn about certain characteristics of the person being monitored (e.g., movements, facial recognition, the person's vehicle, etc.), and based upon such learning, certain characteristics about that person can be specified in the screen view (i.e., the view of the primary camera).

For example, as shown in FIG. 2, certain detected characteristics of a vehicle (260) can be first obtained, and then, particular aspects of the person who owns that vehicle (250) can be further displayed to the viewer.

Here, it can be understood that the enhanced intelligence related to the person and his vehicle can be provided in a variety of ways, as the user interface (UI) and/or user experience (UX) can be adapted to show many different types of information. For example, certain details about a car entering the parking lot can be first detected, information about the person who drove that car can be obtained, the car's parked location and time can be saved in a database, a match about whether to driver of the parked car and the owner can be performed, and then the details about that driver/owner can be displayed. Such procedure can ensure that people who park in the parking lot are authorized employees or permitted guests who visit that facility.

In addition, so-called “video overlays” that provide relatively simple visual outputs or information (such as descriptive text) can be provided to the viewer. For example, in FIG. 2, the primary camera's screen capture view (210) can be augmented with text outputs (260) related to a probability of identification with respect to the person being tracked, as well as additional information (250) that provides more details about that person. The depicted overlays in FIG. 2 are merely exemplary, and those skilled in the art can clearly understand that various other types of useful information may be provided or displayed to the viewer in a variety of ways, as needed.

The example outlined above, namely Phase 0, would occur entirely in 2D and does not involve grouping or combining any images. However, the end result, namely, the value generated for the user/viewer in terms of efficiencies, is entirely consistent with the inventive aspects in Phase 1, in Phase 2 and/or in Phase 3. Namely, instead of the user/viewer having to toggle through numerous screen views from multiple cameras/angles, the network of secondary cameras would be leveraged to automate this process via adding particular visual notifications, such as by providing a color change of the bounding box of an image (i.e., person or object) captured and displayed from the primary camera (210) based on intelligence provided by a secondary camera (220).

When compared to Phase 1, such Phase 0 may be a more low-level and cost-effective implementation from a product development perspective.

It should be noted that implementation of Phases 0 through 3 can be combined in a variety of ways. For example, a surveillance system may initially track persons and objects under Phase 0, and Phase 1 can later be selective activated (due to user manual interaction or automatic triggering) upon detection of high-risk persons or objects in Phase 0 to thus allow for more intensive tracking to be performed in Phase 1. Alternatively, potential customers interested in a surveillance system, according to one or more embodiments herein that can support at least two among Phases 0 through 3, can choose and customize at least two Phases that would be desirable according to their needs.

Referring to FIG. 3 and FIG. 4, according to Phase 1, a single screen 2D viewing experience (310, 410) is to be achieved. To do so, two or more images that contain a person or object (411) being tracked are obtained. Then, such images are grouped or combined together for displaying (419) on a single screen (410).

Here, the image grouping or combining can be achieved in a variety of ways. For example, at least one primary camera (416) is responsible for obtaining primary images or videos, which are displayed on a user viewable screen. In addition, with respect to secondary images or videos from secondary cameras (412, 414, 418), video analytics and image processing are applied in order to determine how and when image grouping should be performed. In such manner, users or security personnel will be able to take advantage of the single screen 2D viewing experience (410) without having to toggle between multiple images while tracking a person or object of interest (411).

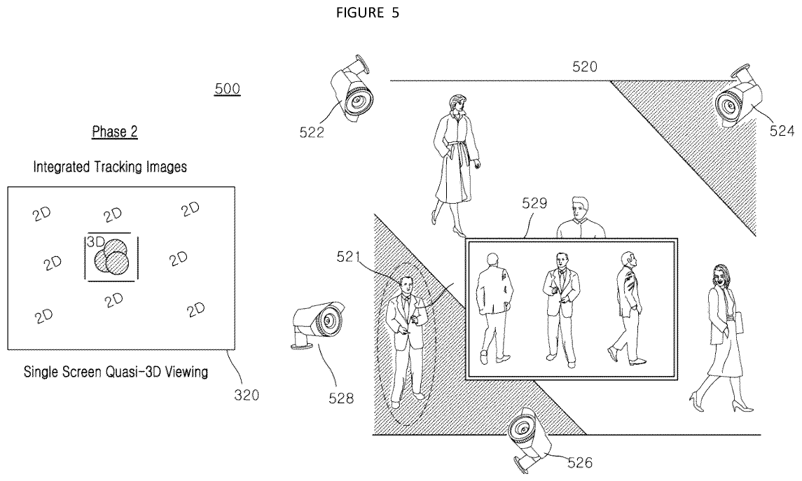

In Phase 2, with reference to FIGS. 3 and 5, a single screen quasi-3D viewing experience (320, 520) is to be achieved. To do so, two or more images that contain a person or object being tracked (521) are obtained and integrated together.

Here, the integration used in Phase 2 involves more image processing that the grouping (or combining) performed in Phase 1. For example, images or video from at least one primary camera (526) is provided as an overall background-like viewing environment. In addition, using a bounding box (529) or similar image presentation or depiction effect, a person or object of interest can be displayed in an overlay manner at a central or other region of the background presentation. It can be said that a picture-in-picture (PIP) effect is achieved. Here, images of the person or object of interest can be processed to output semi-3D or quasi-3D effects in order to provide more life-like or more informative depictions thereof. For example, on the assumption that a person of interest is being initially tracked in a surveillance area by at least one primary camera. Then, one or more secondary cameras (522, 524, 528) can additionally track that person from different viewing angles from different camera locations within the surveillance area. Certain images from the primary and secondary cameras are then matched, grouped, stitched, and/or otherwise combined together for graphical display thereof. Here, some examples of certain image matching and stitching techniques are described in one or more Applicant's commonly owned application publications, such as WO2023172031A1 (Generation of panoramic surveillance image), which is incorporated herein by reference in its entirety.

Such quasi-3D presentation can be generated by system processing in an automatic manner, such as through detection of certain events related to that person being tracked. Alternatively, such quasi-3D image processing is performed upon user instructions or option selection. Such manual commands from the user may save processing power in that quasi-3D image processing need not be performed when not desired.

It should be noted that the video analytics, image processing, image stitching, and/or their related procedures performed in accordance with one or more embodiments described herein (such as for the quasi-3D viewing experience) cannot be practically performed by the human mind or are virtually impossible by humans, because of the complexity and difficulties of the necessary calculations involved. As understood by those skilled in the art, such calculations and/or processes need to be performed by means of computer processors, possibly in combination with additional integrated circuits (IC), other circuitry, hardware, firmware, and/or software. Certain types of artificial intelligence (AI) algorithms, large language models (LLMs), machine learning (ML), etc. may be additionally employed to augment such computer processor implemented calculations in the described embodiments.

Compared to Phase 3 to be described later, Phase 2 has less complexity involved in capturing and stitching together images from multiple cameras to form a quasi-3D rendering. Such is achieved by leveraging multiple cameras within a coverage area to enhance the intelligence of the image generated from the primary camera(s). For example, Phase 2 could be implemented as a risk assessment and/or classification tool. In other words, if a secondary camera(s) detects a perceived risk, such as a weapon, a theft, etc., this information would be leveraged to change the color of the viewable bounding box (419, 529) for the individual being tracked (and being captured and viewable from the primary camera) from, as an example, green to yellow or green to red.

From the perspective of the security personnel that uses a surveillance system that supports Phase 0, 1 and/or 2 according to one or more embodiments herein, they may only need to focus on a single view (i.e., primary views) in each direction of an entrance/exit area or other such coverage area with this solution. Secondary cameras positioned throughout the space (or coverage area) would “automatically” assist with the intelligence capturing by feeding any perceived risks into the viewable images generated from the primary cameras. The resulting viewing experience is improved since security personnel would not need to toggle between multiple cameras to gain deeper visual insights of a coverage area. In essence, the network of cameras would perform this task automatically. However, a user selectable option for toggle viewing or viewing between different multiple screens can be implemented.

Here, the solution architecture can be thought to have a “master” and “slave” relationship used in some IT systems, whereby the secondary camera(s) are leveraged primarily to support the enhanced functionality of the images being generated from the assigned primary camera(s). For example, “best views” or “video clips” from the secondary camera(s) justifying a change in perceived risk status could be associated and accessible for an individual being assigned a higher potential risk “yellow” or “red” color bounding box.

In summary, this Phase 2 approach simplifies the technical challenges faced with the full 3D viewing concept (i.e., Phase 3 described hereafter), but retains the improved user experience with applicability to wide variety of scenarios, such as for a “visual weapons detection” environment.

It should be noted that the bounding box or other similar depiction on a display screen according to one or more embodiments for Phases 0 through 3 can be considered to be related to augmented reality (AR) and/or other types of user-experience viewing effects.

Namely, with respect to a real-time view captured via one or more cameras, adding useful graphical information thereto for user recognition achieves an improved viewing experience. Here, augmented reality (AR) refers to providing an interactive experience that enhances the real world with computer-generated perceptual information. Such can be achieved by using software, apps, and hardware such as AR glasses, augmented reality overlays digital content onto real-life environments and objects.

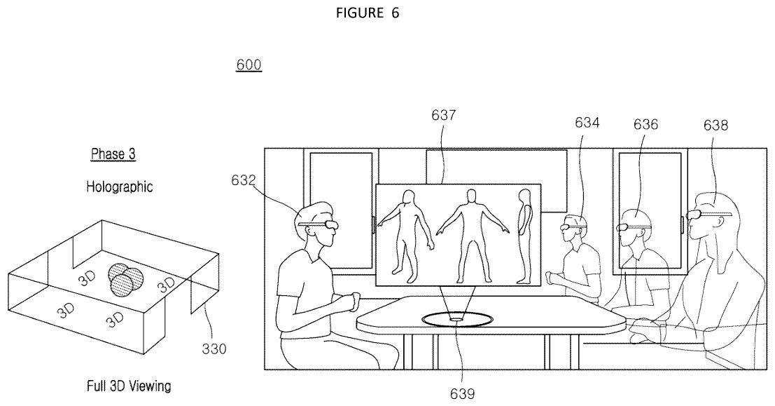

In Phase 3, with reference to FIGS. 3 and 6, a single screen full 3D viewing experience (330, 600) is to be achieved. To do so, more image processing than that performed in Phase 2 is required. Here, various types of 3D image processing can be employed.

It should be noted that 3D reconstruction from multiple images is the creation of three-dimensional models from a set of images. This can be considered to involve a reverse process of obtaining 2D images from 3D scenes.

An image is a projection from a 3D scene onto a 2D plane, and such projection results in the loss of depth information. However, if two images are available, then the position of 3D points can be found as the intersection of the two projection rays. This process is referred to as triangulation. The key for this process is knowing and processing the relationship between multiple views which convey the information that corresponding sets of points of a person or object of interest that related to the poses and the calibration of the camera.

The process of converting multiple 2D images into 3D model consists of a series of steps:
Camera calibration consists of intrinsic and extrinsic parameters, without which at some level no arrangement of algorithms can work.
Such camera calibration is typically required for determining depth and generating 3D images;
Depth determination is a challenging part in the entire 3D rendering process, as it calculates the 3D component (i.e., depth), which is missing from any given image. The correspondence problem, finding matches between two images so the position of the matched elements can then be triangulated in 3D space requires special image processing; and
Upon obtaining multiple depth maps, such have to be combined to create a final mesh by calculating depth and projecting out of the camera. Camera calibration is further used to identify where the multiple meshes created by depth maps can be combined to develop a larger one, providing more than one view for observation.

Once a complete or satisfactory 3D mesh is generated, color processing based on the original objects being captures can be applied to the 3D mesh. This can be achieved by combining techniques related to image projection, surface texture combinations, super resolution processing, applying specular and light diffusion properties, and the like. It can be understood that Phase 3 is not limited to any particular 3D image processing technique, as a variety of 3D image/video generation methods are applicable.

Referring to FIG. 6, an exemplary full 3D viewing embodiment (330, 600) is shown. A holographic meeting situation is depicted, but it can be understood that various other types of scenarios would be possible. A viewer is virtually attending a meeting looking at his screen (630) of a physical meeting room thereof. One participant (632) is sitting at one side in a real physical meeting room, while three additional participants (634, 636, 638) are attending via their holographic images. A holographic projection device (639) or the like is on the meeting room table and operating to project numerous holograms of a person (637) which can be viewed by all participants. full 3D viewing embodiment (330, 600) can allow one or more participants to physically and/or virtually interact with the holographic person (637) being projected.

As a result, the single screen full 3D viewing experience can provide the viewer with more meaningful information and intelligence with respect to the person(s) or object(s) being tracked or viewed.

For one or more of Phase 0 through 3, the background image from one or more cameras can undergo some type of additional image processing. For example, if objects in the background image or video stream are relatively static or does not change very much or is of relatively low interest, a more simplified background image can be processed and displayed. Upon user viewing, such simplified background image may appear blurred or static or simplified. Various types of image processing techniques can be used to achieve such blurring or simplified display effects. By doing so, less image processing would be performed for a relatively unimportant background scene that may contain minimal changes therein. In this manner, the bounding box, picture-in-picture (PIP), augmented reality and/or other viewing effects on the screen can be more emphasized when providing helpful visual information to the viewer.

Various features with respect to Phases 0 through 3 are implemented in a variety of embodiments and scenarios to be described in detail hereafter.

### First Embodiment

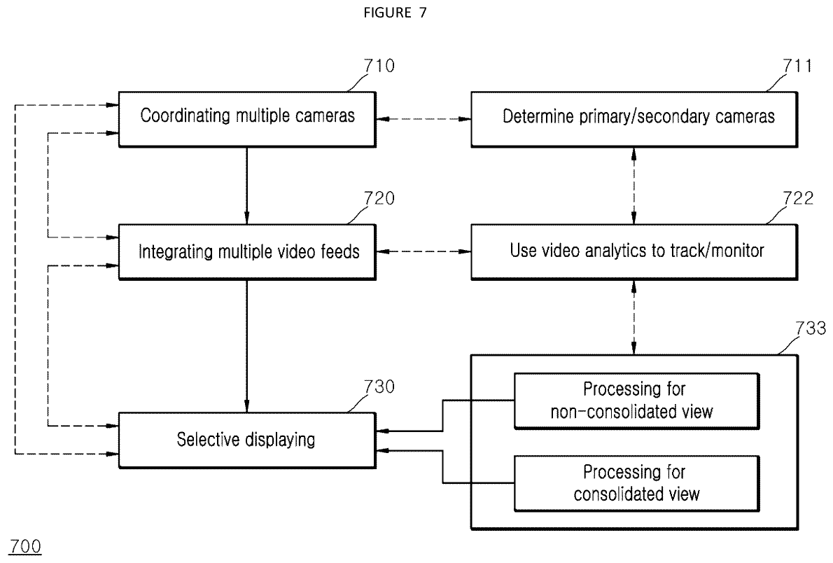

With reference to FIG. 7, at least some basic concepts and/or broad features related to at least the first embodiment provides for a method comprising the steps of:
coordinating (710) one or more operations of multiple surveillance cameras, each camera having its own field-of-view (FOV), that are operatively linked to each other via network connectivity, the multiple surveillance cameras including at least one camera designated as a primary camera and at least one other camera designated as a secondary camera, the primary and secondary cameras providing video feeds related to a multi-camera coverage area;
integrating (720) at least some portions of multiple video feeds, from the multiple surveillance cameras including the primary and secondary cameras, to obtain consolidated images by leveraging video analytics of the multiple surveillance cameras for tracking or monitoring of at least one target of interest; and
selectively (730) displaying either a non-consolidated view or a consolidated view comprising a comprehensive 2D view of the multi-camera coverage area together with a quasi-3D view of at least a portion of the target of interest being shown within a single bounding box, the quasi-3D view being based upon the consolidated images.

Here, the security or surveillance cameras may be those that are currently used in the surveillance industry. For example, Hanwha's products for pan tilt zoom (PTZ) cameras can be employed, but the embodiments described herein are not limited thereto. The features of such cameras (as explained in commonly owned U.S. patents, such as U.S. Pat. Nos. 10,043,079B2, 10,783,648B2 and 10,341,616B2) will not be explained in detail but are still part of this disclosure via incorporation by reference of these patents in their entirety. The network connectivity can be achieved in a variety of ways, including but not limited to, LAN connections, wireless communications, ad hoc networking, edge computing, telecommunications and the like.

In the coordinating step (710), signaling and/or data transfer can take place between a central controller (such as a server, central computing device, etc.) and a plurality of surveillance cameras that are strategically located in a particular surveillance area. The cameras and central controller have network connectivity that allows for wired and/or wireless communications therebetween. The central controller can select various images from the cameras and perform at least some image processing thereon such that a desired composite image is displayed to the user. For such selection of images, the central controller can rely on algorithms, artificial intelligence (AI) techniques, event detection, and the like or any combination of these. As an example, the central controller can employ AI techniques to determine and/or anticipate which images would be best for selection with respect to a moving target that is being tracked by multiple cameras.

Here, a designation (711) of the cameras to be primary or secondary is dynamically performed or changed in accordance with particular on-going or future events in the coverage area and/or certain image characteristics related to the target(s) under surveillance, such as movement of the target of interest being tracked or monitored in the multi-camera coverage area. The central controller and/or another control device can perform the designation in an automated manner based upon detection of the events and/or characteristics described above. For example, upon initial designation of a first camera to be primary and multiple other cameras designated as secondary, as the target moves in the surveillance area, the first camera may no longer provide the best view of the target (as determined by image processing algorithms, AI techniques and/or other object detection techniques) and thus a different camera having a better capture view can be automatically switched to be the primary camera. Upon changing the primary camera, the first camera can then be re-designated as secondary or provided as a non-designated camera. Alternatively, and/or additionally, such designation could be performed with user intervention, by allowing the user to select which if the cameras should be switched to be the primary camera while the user views the target.

In the integrating step (720), multiple images of the target are combined. Such image combining can be achieved in a variety of ways. For example, as the most basic method, multiple views of the target object can be simply shown in separate windows or screens that are all viewable by a user. However, more meaningful information could be provided to the user if such multiple images are integrated in a more intuitive manner. One such manner would be to provide consolidated images by leveraging video analytics (722) of the multiple surveillance cameras for tracking or monitoring of at least one target of interest. For example, central controller and/or another control device can perform the integration by detecting (via image processing algorithms, AI techniques and/or other object detection techniques) and using only those images from particular cameras that are capturing meaningful images of the target, while images from other cameras are not combined.

In the selectively displaying step (730), image consolidation is provided in a more intuitive way. Namely, based upon the images decided upon in the previous integrating step, the integrated images can be processed to allow selective displaying thereof (733). For example, a comprehensive 2D view of the multi-camera coverage area can be provided as a base image. In addition, a so-called “quasi-3D view” of at least a portion of the target of interest can be processed and shown within a single bounding box or some other type of graphical representation that provides emphasis on the target being shown to the user.

Here, such selective displaying can be triggered automatically as determined by image processing algorithms, AI techniques and/or other object detection techniques, upon detection of particular on-going or future events in the coverage area and/or certain image characteristics related to the target(s) under surveillance.

Alternatively, and/or additionally, such selective displaying could be performed with user intervention, by allowing the user to select and decide upon how the consolidated images are to be displayed.

For this method, the integrating is performed by using image timing information and image sizing information from the multiple surveillance cameras to obtain the consolidated images.

Here, integration of multiple images from various cameras can be achieved in a variety of ways. For example, the images being captured would have capture timing information and/or image size related information associated thereto. Image resolution, color related characteristics, lighting information, and the like would be additional types of information that can be obtained from the multiple cameras. Depending on what type of target is being monitored and what the environmental conditions at the surveillance area are like, a different combination of such various types of image related information can be used for image integration as needed. Image timing and image sizing could be designated as two types of basic parameters to be used in such image integration. By employing both image timing and image sizing, multiple images from multiple cameras could be combined in a more intuitive manner and can allow the user to view the target under surveillance in a more effective manner.

For this method, the single bounding box is graphically inserted into, layered upon or otherwise mapped to the comprehensive 2D view such that more than one camera angle is presented within the single bounding box.

Here, in order to provide the user with more useful image viewing, a bounding box or similar type of graphical indication can be presented on the screen using various types of image processing techniques. For example, as bounding box image processing has been used for and has user familiarity in the surveillance industry, employing such could provide a simple solution with respect to implementing one or more embodiments described herein for consolidated viewing of multiple images from numerous cameras. The bounding box depiction could be static, in that the same size could be maintained while the user is viewing the target. Alternatively, and/or additionally, such bounding box depiction could be provided in a dynamic manner. For example, one or more colors for the bounding box can be changed automatically or manually upon detection of certain characteristics of the target. Also, the size of the bounding box could be changed and/or given animated effects such that that target therein can be more noticeable. However, other types of graphical object emphasizing techniques, such as graphical outlines, image simplification, icon depictions, etc. can also be used in an alternative and/or augmented manner in addition to the comprehensive 2D view with or without a bounding box depiction.

For this method, the quasi-3D view is provided without employing image processing related to three-dimensional (3D) rendering.

Here, such quasi-3D view can be achieved in a variety of ways.

For example, certain image stitching techniques, as described in, for example, Hanwha's KR10-2339825B1 and/or U.S. Pat. No. 10,979,645B2, which are respectively incorporated by reference in its entirety to this disclosure, can be employed. The main idea behind such quasi-3D view is to perform some image processing, to provide meaningful consolidated viewing of multiple images, that is less burdensome than certain conventional 3D rendering techniques. For example, the quasi-3D view can be provided in a simplified manner using minimal graphics processing, if the target object is complicated and/or if its surroundings or other background objects are too distracting.

For this method, displaying of the consolidated view precludes a need for toggling or switching between different windows or screens, which results in an enhanced multi-camera viewing experience.

Here, such toggling can be achieved in an automated manner and triggered upon detection of certain events, such as movement of the target being captured. Different types of image processing algorithms, AI techniques and/or other object detection techniques can be employed to provide such automatic toggling. Although typically, automatic toggling could be more efficient for user viewing, an option to provide direct user intervention through manual selection can cause manual toggling to be performed, if such is desired.

For the first embodiment, it should be noted that the video analytics, image processing, image stitching, and/or their related procedures performed in accordance with one or more embodiments described herein (such as for the quasi-3D viewing experience) cannot be practically performed by the human mind or are virtually impossible for humans, because of the complexity and difficulties of the necessary calculations involved. As understood by those skilled in the art, such calculations and/or processes need to be performed by means of computer processors, possibly in combination with additional integrated circuits (IC), other circuitry, hardware, firmware, and/or software. Certain types of artificial intelligence (AI) algorithms, large language models (LLMs), machine learning (ML), etc. may be additionally employed to augment such computer processor implemented calculations in the described embodiments.

### Second Embodiment

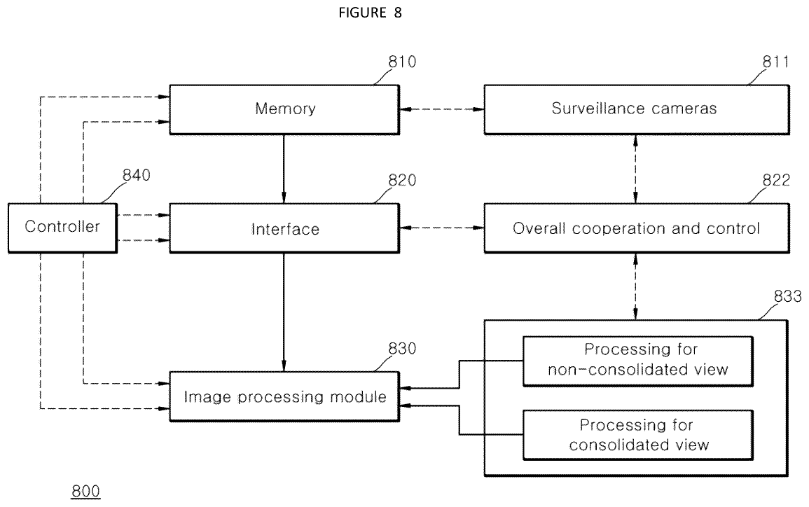

With reference to FIG. 8, at least some basic concepts and/or broad features related to at least the second embodiment provides for an apparatus comprising:
a memory (810) that contains information related to video feeds from multiple surveillance cameras (811) for a multi-camera coverage area, each camera having its own field-of-view (FOV) and the cameras being operatively linked to each other via network connectivity;
an interface (820) that cooperates with the multiple surveillance cameras (811) to receive the video feeds therefrom and deliver control signals to the multiple surveillance cameras;
an image processing module (830), operatively connected with the memory (810) and the interface (820), that performs image processing on the video feeds from the multiple surveillance cameras to cause integrating of at least some portions of multiple video feeds to obtain consolidated images by employing video analytics of the multiple surveillance cameras for tracking or monitoring of at least one target of interest; and
a controller (840), operatively connected with a display, the memory (810), the interface (820) and the image processing module (830), that provides the control signals to the multiple surveillance cameras and offers an enhanced multi-camera viewing experience by providing instructions, to the image processing module and the display, for selectively displaying (833) either a separated view of two or more fields-of-view (FOVs) from two or more cameras, respectively, or a combined view comprising a comprehensive 2D view of the multi-camera coverage area together with a quasi-3D view of at least a portion of the target of interest.

It should be noted that the apparatus can be a central controller (such as a server, central computing device, etc.) that is operatively connected with a plurality of surveillance cameras that are strategically located in a particular surveillance area. The above-mentioned memory, interface, image processing module, controller and display can be implemented into a single main apparatus or at least one of these elements may be implemented in a different separate apparatus that cooperates with the main apparatus. Some of these elements can even be combined into a single entity. For example, the image processing module and the controller may be implemented into a single graphics processing unit (GPU) or similar processing device. The cameras can be the same or similar to those explained above with respect to the first embodiment.

Here, the memory (810) can be of a variety of types, including but not limited to a storage device, a hard disk, a cache, a buffer, a digital media recorder, and the like. Also, two or more of the same or different types of devices can be implemented together to thus function as the “memory” described herein.

Here, the interface (820) can be implemented in a variety of ways. For example, this apparatus can have a wired interface that provides hard wired connections from the multiple cameras and other elements in a surveillance system. Additionally, and/or alternatively, some connectivity can be supported by this interface in a wireless manner. For example, signaling via an over-the-air interface can be employed. Various types of wireless or radio communication standards (such as LTE, 5G, Wi-Fi, etc.) are supported by such interface to allow seamless sending and receiving of data and information. A combination of wired and wireless interfacing can also be implemented, as some network elements may be better suited to one type of interfacing over a different interfacing type.

Here, the image processing module (830) can be comprised of hardware, software, firmware, and/or some combination thereof. For example, a so-called “video calibrator” (as described in Applicant's commonly owned U.S. Pat. No. 10,979,645) may be employed to handle the functions of the image processing module described in the embodiments herein. Namely, the video calibrator can operate to employ reference information (including image calibration information) from multiple images to cause integrating of at least some portions of multiple video feeds to obtain consolidated images. Here, video analytics of the multiple surveillance cameras for tracking or monitoring of at least one target of interest can be employed.

Here, the controller (840) can be a CPU, a GPU or a combination thereof. By being operatively connected with a display, the memory, the interface and the image processing module, such controller provides control signals to the multiple surveillance cameras and offers an enhanced multi-camera viewing experience. Such is achieved by providing instructions, to the image processing module and the display, for selectively displaying either a separated view of two or more fields-of-view (FOVs) from two or more cameras, respectively.

Alternatively, a combined view comprising both a comprehensive 2D view of the multi-camera coverage area together with a quasi-3D view of at least a portion of the target of interest, can be generated under the control of the controller.

Also, the image processing module and the controller may be implemented into a single element. Namely, a CPU or a GPU may be adapted to handle the functionalities of both the image processing module and the controller in an integrated manner.

In this apparatus, the control signals from the controller include instructions to cause at least one camera, among the multiple surveillance cameras, being designated as a primary camera and at least one other camera being designated as a secondary camera, the primary and secondary cameras providing the video feeds related to a multi-camera coverage area.

Namely, the controller can use various criteria or factors to determine how a primary camera is to be designated. For example, a camera that provides the best overall view of the target or interest could be designated to be primary. Alternatively, a camera that provides the best view of specific characteristics of the target of interest could be designated to be primary. The occurrence of certain events related to the target of interest could be another factor in how to designate a camera to be primary.

In this apparatus, the control signals from the controller cause the designation of the cameras to be primary or secondary to be dynamically performed or changed in accordance with characteristics or movement of the target of interest being tracked or monitored in the multi-camera coverage area.

Namely, the designations of the primary and secondary cameras can be changed to adjusted in real-time, as video feeds are being captured and depending upon changes in the target of interest with respect to its movements or other detected characteristics. Such dynamic changing of such designations may require more processing power at the controller and/or other components. As such, certain monitoring situations may use operational settings that require minimal designation changes in order to minimize the image processing involved, when compared to continuous real-time image capturing and dynamic camera designation changes.

In this apparatus, the controller, in cooperation with the image processing module and the display, cause the quasi-3D view to be generated without employing image processing related to three-dimensional (3D) rendering.

Namely, similar to the first embodiment, such quasi-3D view can be achieved in a variety of ways. For example, certain image stitching techniques can be employed. The main idea behind such quasi-3D view is to perform some image processing, to provide meaningful consolidated viewing of multiple images, that is less burdensome than certain conventional 3D rendering techniques. For example, the quasi-3D view can be provided in a simplified manner using minimal graphics processing, if the target object is complicated and/or if its surroundings or other background objects are too distracting.

In this apparatus, the integrating, by the image processing module, is performed by using image timing information and image sizing information from the multiple surveillance cameras to obtain the consolidated images.

Namely, in addition to or alternative to image stitching techniques described above, other types of information related to the images may be employed to obtain the consolidated images. For example, image timing information, image sizing information, pixel related information, image resolution, and the like are merely some examples that can be employed.

In this apparatus, the controller provides instructions, to the image processing module and the display, to cause the quasi-3D view of at least a portion of the target of interest to be shown within a single bounding box, the quasi-3D view being based upon the consolidated images.

Namely, as explained in the first embodiment, so-called bounding box image processing can be performed. However, other types of graphical object emphasizing techniques, such as graphical outlines, image simplification, icon depictions, etc. can also be used in an alternative and/or augmented manner for the quasi-3D view with or without a bounding box depiction.

In this apparatus, at least one among the controller and the image processing module operate to causes displaying of a visual indicator, related to a change in perceived risk status about the target of interest, based upon video analytics information from the secondary cameras to enhance intelligence related to one or more images from the primary view that are used in deciding on the change in perceived risk status to cause the displaying of the visual indicator.

Namely, visual indicators that are different from a bounding box can be processed and displayed to show the user or viewer about a perceived risk, such as the presence of a weapon or other dangerous object on the target of interest. Such visual indicators may be dynamically changed in its depiction when there are changes in the potential risk status. For example, if a first view from a first camera does not allow a clear determination of what the risk status is, the visual indicators may be depicted as a yellow color, and when a second camera picks up a clearer view showing that the target of interest is a person holding a dangerous object, then the visual indicators may be changed to a red color in order to alert the viewer or user about a higher risk status of the target under surveillance. In such manner, target of interest can be monitored in a more realistically manner with real-time updates to let security personnel to take action or to allow other measures to be taken with respect to the elevated risk status.

For the second embodiment, it should be noted that the video analytics, image processing, image stitching, and/or their related procedures performed in accordance with one or more embodiments described herein (such as for the quasi-3D viewing experience) cannot be practically performed by the human mind or are virtually impossible for humans, because of the complexity and difficulties of the necessary calculations involved. As understood by those skilled in the art, such calculations and/or processes need to be performed by means of computer processors, possibly in combination with additional integrated circuits (IC), other circuitry, hardware, firmware, and/or software. Certain types of artificial intelligence (AI) algorithms, large language models (LLMs), machine learning (ML), etc. may be additionally employed to augment such computer processor implemented calculations in the described embodiments.

### Third Embodiment

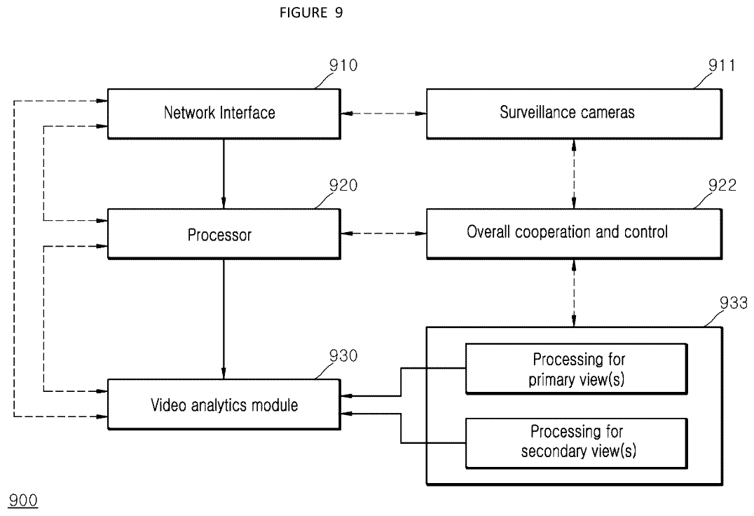

With reference to FIG. 9, at least some basic concepts and/or broad features related to at least the third embodiment (900) provides for a system comprising:
a network interface (910), which cooperates with multiple surveillance cameras (911) to receive video feeds therefrom and to deliver control signals thereto, and obtaining, from at least one primary camera, information about a primary view that comprises one or more images of a target of interest in a coverage area and obtaining, from one or more secondary cameras, information about one or more secondary views, which have different fields-of-view (FOVs) than that of the primary view, that also comprises one or more images of the target of interest in the coverage area; and
a processor (920) that performs image processing (922) on the video feeds to cause providing of a consolidated multi-camera viewing experience on a single display window or screen that offers more user efficiency and comprehensive intelligence related to the target of interest when compared to a system that lacks the processor and the network interface.

Here, the network interface (910) can be adapted to support wired and/or wireless communications to send and receive signals, data, information, and the like. Namely, such system cooperates with multiple surveillance cameras to receive video feeds therefrom and to deliver control signals thereto. Such control signals can be used to pan, tilt or zoom certain cameras while monitoring a target of interest. Such control signal may also be used to send or receive particular information about the images and video feeds being captured.

Also, the network interface is used for obtaining, from at least one primary camera, information about a primary view that comprises one or more images of a target of interest in a coverage area and obtaining, from one or more secondary cameras, information about one or more secondary views, which have different fields-of-view (FOVs) than that of the primary view, that also comprises one or more images of the target of interest in the coverage area.

Meanwhile, the processor (920) can be similar to those described in the first and/or second embodiments mentioned above. Alternatively, if the processor is implemented in one or more of the multiple cameras, a camera-integrated GPU may be sufficient to cause the providing of a consolidated multi-camera viewing experience on a single display window or screen at a particular location, such as control center or surveillance desk. Despite the particular type of processor being employed, such system would offer more user efficiency and comprehensive intelligence related to the target of interest when compared to a system that lacks the processor and the network interface of this third embodiment, due to the provision of a consolidated multi-camera viewing experience.

This system further comprises: a video analytics module (930), operatively connected with at least one among the processor (920) and the network interface (910), to employ at least one among video analytics, artificial intelligence (AI), cloud server processing and image rendering to the video feeds to provide the consolidated multi-camera viewing experience.

Here, the video analytics module can be comprised of software that is executed by hardware and/or firmware. Video analytics uses advanced algorithms and machine learning to monitor, analyze and manage large volumes of video. Video inputs are digitally analyzed and transformed into intelligent data, which allows for making decisions related to surveillance applications via the consolidated multi-camera viewing experience. Video analytics software may be pre-installed in the surveillance cameras, on a network video recorder (NVR), or as a built-in or third-party plugin to the video management software (VMS). So-called open VMS platforms may allow users to choose the optimal hardware for the particular security surveillance infrastructure.

Artificial intelligence (AI) can be applied to video processing in a variety of ways. Video analytics can employ AI to automate tasks without or with minimal human intervention by applying real-time video processing. For example, AI-powered visual inspection techniques can allow target of interest tracking to be more efficient by detecting events, objects in people in real-time. AI-Based Video Analytics, also known as Video Content Analysis (VCA), Video AI or Intelligent Video, refers to the process of deriving actionable insights and conclusions from data gathered from video. Such AI-Based Video Analytics simplifies and eases the burden of repetitive and tedious tasks of long-hour video observation by humans. AI can detect and observe certain types of data and can also be trained with large volumes of video footage to detect, identify, categorize and automatically tag specific objects. Machine Learning (ML), as a subset of AI, employs algorithms used to analyze data, learn from the information that has been collected, then apply this knowledge to base future decisions upon with zero to minimal human intervention. Deep Learning (DL), as a subset of ML, uses artificial neural networks to mimic the learning processes of a human brain. Deep Learning mimics the way human brains process information in a non-linear fashion. Namely, AI, ML and DL are tools used to assist humans in understanding video content, and make automated decisions based on observations made from the data collected.

Cloud servers are virtual (not physical) servers running in a cloud computing environment that can be accessed on demand by numerous users. Cloud servers work just like physical servers by performing similar functions, such as storing data and running applications. Cloud services are typically hosted by third-party providers to deliver computing resources over a network, such as the internet. Cloud servers are created by using virtualization software (known as a hypervisor) to divide physical servers into multiple virtual servers. A hypervisor abstracts the server's processing power and pools them together to create virtual servers. The embodiments described herein can take advantage of such cloud servers and cloud server processing to provide for the consolidated multi-camera viewing experience. Such cloud server processing may relieve the burden of the controller or processors in the system and/or those within the surveillance cameras.

Image rendering can refer to the processing of digital image, 2D models or 3D models using computer software. A software application or component that performs rendering is called a rendering engine, render engine, rendering system, graphics engine, or a renderer. Such rendering requires the use of specific types of information, such as 2D vector graphics (which can include coordinate information of lines, curves and shapes in the image, bitmap data, color space information, etc.) and 3D geometry (which can include camera information describing how the scene is being viewed with respect to position, direction, focal length, and field of view). For producing 2D images on a screen from 3D representations stored in a scene file are handled by a rendering device such as a GPU. A GPU is a purpose-built device that assists a CPU in performing complex rendering calculations.

In the case of 3D graphics, scenes can be pre-rendered or generated in real-time. Pre-rendering is a slow, computationally intensive process, where scenes can be generated ahead of time, while real-time rendering is often done for applications that dynamically create scenes. 3D hardware accelerators can improve real-time rendering performance. More recently, neural rendering, which is a rendering method using artificial neural networks (ANNs) has been developed. Neural rendering includes image-based rendering methods that are used to reconstruct 3D models from 2-dimensional images. One method is called photogrammetry, whereby a collection of images from multiple angles of an object are turned into a 3D model.

By using various types of image rendering techniques as described above, the consolidated multi-camera viewing experience according to the embodiments described herein can be achieved.

In this system, the video analytics module performs processing to cause enhancing of the primary view by adding or supplementing information from the secondary views without a need to monitor separate views on multiple windows or screens.

Here, the information from the secondary views can include at least one among graphics, visual indicators, text, icons, audible outputs and tactile outputs. As such, a consolidated multi-camera viewing experience is provided on a single display window or screen that offers more user efficiency and comprehensive intelligence related to the target of interest when compared to a system that lacks the processor and the network interface.

In this system, the processor and the video analytics module cooperate to cause a quasi-3D viewing being provided without employing image processing related to three-dimensional (3D) rendering.

As explained in the first and/or second embodiments, such quasi-3D view can be achieved in a variety of ways. For example, certain image stitching techniques can be employed. The main idea behind such quasi-3D view is to perform some image processing, to provide meaningful consolidated viewing of multiple images, that is less burdensome than certain conventional 3D rendering techniques. For example, the quasi-3D view can be provided in a simplified manner using minimal graphics processing, if the target object is complicated and/or if its surroundings or other background objects are too distracting.

In this system, the processor and the video analytics module cooperate to display a visual indicator, based upon a change in perceived risk status about the target of interest, based upon leveraging of the secondary cameras to enhance the one or more images from the primary view that are used in deciding on the change in perceived risk status to cause the displaying of the visual indicator.

As explained in the first and/or second embodiments, visual indicators can be processed and displayed to show the user or viewer about a perceived risk, such as the presence of a weapon or other dangerous object on the target of interest. Such visual indicators may be dynamically changed in its depiction when there are changes in the potential risk status. For example, if a first view from a first camera does not allow a clear determination of what the risk status is, the visual indicators may be depicted as a yellow color, and when a second camera picks up a clearer view showing that the target of interest is a person holding a dangerous object, then the visual indicators may be changed to a red color in order to alert the viewer or user about a higher risk status of the target under surveillance. In such manner, target of interest can be monitored in a more realistically manner with real-time updates to let security personnel to take action or to allow other measures to be taken with respect to the elevated risk status.

In this system, the processor and the video analytics module cooperate to display the visual indicator in a form of a bounding box graphical depiction that provides a visible indication of harmful objects or actions related to the target of interest in the primary view.

As explained in the first and/or second embodiments, so-called bounding box image processing can be performed. However, other types of graphical object emphasizing techniques, such as graphical outlines, image simplification, icon depictions, etc. can also be used in an alternative and/or augmented manner for the quasi-3D view with or without a bounding box depiction.

In this system, the processor and the video analytics module cooperate to also provide a capability to toggle between the consolidated multi-camera viewing experience and a traditional multi-screen view via multiple windows or screens.

Namely, in some situations, the viewer or user of the surveillance system may wish to view the target of interest in a traditional multi-screen view via multiple windows or screens. To accommodate such, an option of toggling between the consolidated multi-camera viewing experience and a traditional multi-screen view can be implemented.

For the third embodiment, it should be noted that the video analytics, image processing, image stitching, and/or their related procedures performed in accordance with one or more embodiments described herein (such as for the consolidated multi-camera viewing experience) cannot be practically performed by the human mind or are virtually impossible for humans, because of the complexity and difficulties of the necessary calculations involved. As understood by those skilled in the art, such calculations and/or processes need to be performed by means of computer processors, possibly in combination with additional integrated circuits (IC), other circuitry, hardware, firmware, and/or software. Certain types of artificial intelligence (AI) algorithms, large language models (LLMs), machine learning (ML), etc. may be additionally employed to augment such computer processor implemented calculations in the described embodiments.

### Additional Embodiment(s)

It is contemplated that one or more particular features in one embodiment can be combined with certain features in a different embodiment, to thus result in one or more additional embodiments, which still result in the consolidated multi-camera viewing experience. For example, the initial step of coordinating one or more operations of multiple surveillance cameras, as per the first embodiment could be combined with the image processing module of the second embodiment to enhance the image processing performed on the video feeds from the multiple surveillance cameras to cause integrating of at least some portions of multiple video feeds to obtain consolidated images. It can be understood that further combinations of other features (i.e., method steps, components, etc.) from the first, second and third embodiments could be made as well.

Meanwhile, one or more embodiments described herein can perform image processing, video analytics, etc. with respect to at least one or more of the following factors:
Face detection: Identifies key facial features and issues alerts when a face is present;
Virtual line crossing detection: Triggers an alarm when objects are detected crossing a pre-defined virtual line or perimeter;
Loitering detection: Triggers an event when an object enters and rests in a designated virtual zone;
Intrusion detection: Triggers an event when movement is detected in a designated virtual zone;
Enter/exit detection: Detection of objects entering or exiting a designated area;
Appear/disappear detection: Detects the appearance or disappearance of an item in a designated virtual zone;
Audio analytics: Detects and identifies the sound of explosions, gunshots, screams, and breaking glass.

Here, it should be noted that at least some features in one or more the embodiments described herein were not simply developed due to mere reasonable expectation of success based on routine experimentation or routine testing. However, it should be noted that patentability shall not be negated by the manner in which the invention was made and thus, so-called “routine experimentation” in and of itself does not necessarily preclude patentability.

It will be appreciated by those skilled in the art that while the inventive features have been described above in connection with particular embodiments and examples, such inventive features are not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and aspects of the inventive concepts are set forth in the following claims.

What is claimed is:

1. A method comprising:
coordinating one or more operations of multiple surveillance cameras, each camera having its own field-of-view (FOV), that are operatively linked to each other via network connectivity, the multiple surveillance cameras including at least one camera designated as a primary camera and at least one other camera designated as a secondary camera, the primary and secondary cameras providing video feeds related to a multi-camera coverage area;
integrating at least some portions of multiple video feeds, from the multiple surveillance cameras including the primary and secondary cameras, to obtain consolidated images by leveraging video analytics of the multiple surveillance cameras for tracking or monitoring of at least one target of interest; and
selectively displaying either a non-consolidated view or a consolidated view comprising a comprehensive 2D view of the multi-camera coverage area together with a quasi-3D view of at least a portion of the target of interest being shown within a single bounding box, the quasi-3D view being based upon the consolidated images.

2. The method of claim 1, wherein a designation of the cameras to be primary or secondary being dynamically performed or changed in accordance with characteristics or movement of the target of interest being tracked or monitored in the multi-camera coverage area.

3. The method of claim 2, wherein the integrating is performed by using image timing information and image sizing information from the multiple surveillance cameras to obtain the consolidated images.

4. The method of claim 3, wherein the single bounding box is graphically inserted into, layered upon or otherwise mapped to the comprehensive 2D view such that more than one camera angle is presented within the single bounding box.

5. The method of claim 4, wherein the quasi-3D view is provided without employing image processing related to three-dimensional (3D) rendering.

6. The method of claim 5, wherein displaying of the consolidated view precludes a need for toggling or switching between different windows or screens, which results in an enhanced multi-camera viewing experience.

7. An apparatus comprising:
a memory that contains information related to video feeds from multiple surveillance cameras for a multi-camera coverage area, each camera having its own field-of-view (FOV) and the cameras being operatively linked to each other via network connectivity;
an interface that cooperates with the multiple surveillance cameras to receive the video feeds therefrom and deliver control signals to the multiple surveillance cameras;
an image processing module, operatively connected with the memory and the interface, that performs image processing on the video feeds from the multiple surveillance cameras to cause integrating of at least some portions of multiple video feeds to obtain consolidated images by employing video analytics of the multiple surveillance cameras for tracking or monitoring of at least one target of interest; and
a controller, operatively connected with a display, the memory, the interface and the image processing module, that provides the control signals to the multiple surveillance cameras and offers an enhanced multi-camera viewing experience by providing instructions, to the image processing module and the display, for selectively displaying either a separated view of two or more fields-of-view (FOVs) from two or more cameras, respectively, or a combined view comprising a comprehensive 2D view of the multi-camera coverage area together with a quasi-3D view of at least a portion of the target of interest.

8. The apparatus of claim 7, wherein the control signals from the controller include instructions to cause at least one camera, among the multiple surveillance cameras, being designated as a primary camera and at least one other camera being designated as a secondary camera, the primary and secondary cameras providing the video feeds related to a multi-camera coverage area.

9. The apparatus of claim 8, wherein the control signals from the controller cause the designation of the cameras to be primary or secondary to be dynamically performed or changed in accordance with characteristics or movement of the target of interest being tracked or monitored in the multi-camera coverage area.

10. The apparatus of claim 9, wherein the controller, in cooperation with the image processing module and the display, cause the quasi-3D view to be generated without employing image processing related to three-dimensional (3D) rendering.

11. The apparatus of claim 10, wherein the integrating, by the image processing module, is performed by using image timing information and image sizing information from the multiple surveillance cameras to obtain the consolidated images.

12. The apparatus of claim 11, wherein the controller provides instructions, to the image processing module and the display, to cause the quasi-3D view of at least a portion of the target of interest to be shown within a single bounding box, the quasi-3D view being based upon the consolidated images.

13. The apparatus of claim 11, wherein at least one among the controller and the image processing module operate to causes displaying of a visual indicator, related to a change in perceived risk status about the target of interest, based upon video analytics information from the secondary cameras to enhance intelligence related to one or more images from the primary view that are used in deciding on the change in perceived risk status to cause the displaying of the visual indicator.

14. A system comprising:
a network interface, which cooperates with multiple surveillance cameras to receive video feeds therefrom and to deliver control signals thereto, and obtaining, from at least one primary camera, information about a primary view that comprises one or more images of a target of interest in a coverage area and obtaining, from one or more secondary cameras, information about one or more secondary views, which have different fields-of-view (FOVs) than that of the primary view, that also comprises one or more images of the target of interest in the coverage area; and
a processor that performs image processing on the video feeds to cause providing of a consolidated multi-camera viewing experience on a single display window or screen that offers more user efficiency and comprehensive intelligence related to the target of interest when compared to a system that lacks the processor and the network interface.

15. The system of claim 14, further comprising:
a video analytics module, operatively connected with at least one among the processor and the network interface, to employ at least one among video analytics, artificial intelligence (AI), cloud server processing and image rendering to the video feeds to provide the consolidated multi-camera viewing experience.

16. The system of claim 15, wherein the video analytics module performs processing to cause enhancing of the primary view by adding or supplementing information from the secondary views without a need to monitor separate views on multiple windows or screens.

17. The system of claim 16, wherein the processor and the video analytics module cooperate to cause a quasi-3D viewing being provided without employing image processing related to three-dimensional (3D) rendering.

18. The system of claim 17, wherein the processor and the video analytics module cooperate to display a visual indicator, based upon a change in perceived risk status about the target of interest, based upon leveraging of the secondary cameras to enhance the one or more images from the primary view that are used in deciding on the change in perceived risk status to cause the displaying of the visual indicator.

19. The system of claim 18, wherein the processor and the video analytics module cooperate to display the visual indicator in a form of a bounding box graphical depiction that provides a visible indication of harmful objects or actions related to the target of interest in the primary view.

20. The system of claim 19, wherein the processor and the video analytics module cooperate to also provide a capability to toggle between the consolidated multi-camera viewing experience and a traditional multi-screen view via multiple windows or screens.
